(19) United States
(12) Patent Application Publication
(10) Pub. No.: US 2025/0094215 A1
(43) Pub. Date: Mar. 20, 2025

(54) METHOD FOR OPTIMIZING A PROCESS

(71) Applicant: Robert Bosch GmbH, Stuttgart (DE)

(72) Inventor: Oliver Schuenemann, Hildesheim (DE)

(21) Appl. No.: 18/727,464

(22) PCT Filed: Dec. 5, 2022
(86) PCT No.: PCT/EP2022/084354

§ 371 Date: Jul. 9, 2024

(30) Foreign Application Priority Data
Jan. 10, 2022 (DE) 10 2022 200 160.5

(51) Int. Cl. G06F 9/48; G06F 9/38

(52) U.S. Cl. CPC G06F 9/4881; G06F 9/3885; G06F 2209/482

(57) ABSTRACT

A method for optimizing the execution of a process. The method includes: receiving a plurality of applications, which are to be to be executed on a plurality of processor units, of a process to be executed, wherein an execution sequence of the applications is defined by the process; and optimizing the execution of the process by determining optimized execution time plans for the plurality of processor units. In each optimized execution time plan for a processor unit, a chronological execution sequence of the applications to be executed by the processor unit according to the execution sequence of the process is defined based on a starting time for the execution of the process. The optimized execution time plans are characterized in that when the applications are executed in parallel by the processor units according to the optimized execution time plans, the execution duration of the process is minimal.

### FIELD

The present invention relates to a method for optimizing an execution of a process encompassing a plurality of applications by means of a plurality of processor units.

### BACKGROUND INFORMATION

When executing computer-based processes, the general aim is to execute the process as quickly, and as efficiently with regard to resources, as possible. When using a plurality of processor units, it is possible to execute applications of the process in parallel if the design of the process permits parallel execution. In complex processes with a plurality of applications and a plurality of processor units for executing the application, dividing the process among the various processor units for the execution of the applications of the process by the processor units can be a complex task.

### SUMMARY

It is an object of the present invention to provide an improved method for optimizing an execution of a process encompassing a plurality of applications by means of a plurality of processor units.

This object is achieved by a method according to the present invention for optimizing an execution of a process encompassing a plurality of applications by means of a plurality of processor units. Advantageous example embodiments of the present invention are disclosed herein.

According to one aspect of the present invention, a method is provided for optimizing an execution of a process encompassing a plurality of applications by means of a plurality of processor units. According to an example embodiment of the present invention, the method comprises:
receiving a plurality of applications, which are to be to be executed on a plurality of processor units, of a process to be executed, wherein an execution sequence of the applications is defined by the process;
optimizing the execution of the process by determining optimized execution time plans for the plurality of processor units, wherein in an optimized execution time plan for a processor unit, a chronological execution sequence of the applications to be executed by the processor unit according to the execution sequence of the process is defined on the basis of a starting time for the execution of the process, and wherein the optimized execution time plans are characterized in that when applications of the process are executed in parallel by the processor units according to the optimized execution time plans, the execution duration of the process is minimal.

This can achieve a technical advantage of providing a powerful method for optimizing an execution of a process. By determining an optimized execution time plan for each processor unit available for executing applications, which time plan defines a chronological sequence of executions of applications of the process by the relevant processor unit, wherein a total duration of an execution of all applications of an execution time plan by a processor unit is minimized in each case, an optimized utilization of the processor resources and an associated optimized and temporally shortest execution of the complete process by the available processor units can be achieved. By executing the process according to the execution time plans ascertained for the processor units, an optimized execution of the process can be achieved, which results in an optimal utilization of the processor resources. This in turn makes it possible to execute the process in the most resource-efficient way possible.

Within the meaning of the present application, a process is a computer-controlled process that can be executed by means of a plurality of processor units. A process can include a number of subordinate subprocesses. The process or subprocesses comprise at least two applications to be executed serially, a first application with which the process starts and a last application with the execution of which the process ends. Individual applications involve different calculations that have to be performed by the relevant processing unit and that together make up the entire process. Calculation results of individual applications can be used again in executions of other applications of the process that are executed chronologically one after the other. Applications that use calculation results from other applications are executed serially. Applications that can be executed without calculation results of other applications can be executed in parallel to the other applications.

According to one example embodiment of the present invention, the plurality of applications is arranged in a directed acyclic graph, wherein in the directed graph the applications formed as nodes the execution sequence of the applications are defined via edges connecting the nodes.

A technical advantage can thereby be achieved that a compact representation of the process is made possible.

According to one example embodiment of the present invention, the optimization comprises:
assigning a first application of the directed acyclic graph to a first processor unit for executing the first application starting from a start time of the execution of the process by the first processor unit and defining an end point of the execution of the application as a first decision time; assigning one idle application to each of the further processor units for execution by the processor units from the start time of the execution of the process to the first decision time, wherein during the execution of the idle application the relevant processor unit is put into an idle state;
calculating an execution path with the shortest execution duration through the directed acyclic graph starting from the first application of the directed acyclic graph, wherein the execution path comprises the applications connected in the directed acyclic graph to the first application and to each other with corresponding edges, and wherein the execution duration of the execution path is formed as a sum of execution durations of the applications of the execution path;
assigning a second application, with the shortest execution duration, directly connected to the first application in the execution path to the first processor unit for execution by the first processor unit starting from the first decision time and defining an end point of the execution of the second application as the second decision time;
assigning further applications in the directed acyclic graph which are directly connected to the first application and do not belong to the execution path with the shortest execution duration to the further processor units for execution by the further processor units starting from the first decision time and defining end points of the execution of the further applications as further decision times if the directed acyclic graph comprises, in addition to the execution path with the shortest execution duration, further execution paths starting from the first application and arranged in parallel with the execution path with the shortest execution duration;
assigning idle applications to further processor units for execution of the idle applications by the further processor units starting from the first decision time up to the second decision time or up to an earliest decision time from the group of the second decision time and the further decision times, if the directed acyclic graph does not comprise, in addition to the execution path with the shortest execution duration, any further execution path starting from the first application and arranged in parallel with the execution path with the shortest execution duration, or if a number of the further processor units is greater than a number of the further execution paths;
calculating, for the second application to be executed by the first processor unit and the further applications to be executed by the further processor units in parallel with the second application, execution paths with in each case the shortest execution durations through the directed acyclic graph, starting in each case from the second application or from the further applications of the directed acyclic graph, and assigning further applications connected, in the execution paths with the shortest execution durations, directly to the second application or to the further applications to the first processor unit or to the further processor units for execution by the first processor unit or the further processor units starting from the second decision time or the further decision times, and defining endpoints of the executions of the further applications as further decision times;
assigning idle applications to all processor units for which no application was assigned for the relevant decision time for execution of the idle application until a decision time that is chronologically next from the relevant decision time;
continuing with the calculation of execution paths for the further applications and the assignment of further applications of the calculated execution paths to the respective processor units for executing the applications and the assignment of idle applications to the processor units until the last application of the directed acyclic graph is reached and defining for each processor unit sequences, ascertained in this way for the processor units, of applications and idle applications to be executed by the respective processor units as execution time plans of each of the processor units.

This provides a technical advantage of achieving structured calculations of the optimized execution time plans. By assigning the applications to the individual processor units for execution by the respective processor units, taking into account that parallel execution of applications takes place if such parallel execution is enabled by the process, an optimal utilization of the plurality of processor units and an associated optimized execution of the process can be achieved. By calculating the execution paths with the shortest execution durations of the applications of each of the execution paths, a precise estimate of the execution duration for the applications selected and assigned to the relevant processor unit in each case can be achieved. This enables a precise determination of the shortest total execution time of the plurality of applications assigned to a relevant processor unit. By assigning idle applications, processor units can be temporarily put into an idle state for an arbitrarily specifiable period of time if no applications can be found for the respective processor units to execute during this period. Idle states allow executions of applications by one processing unit to be temporally coordinated with executions of other applications by other processing units. This coordination makes it possible to maintain the application execution sequence defined in the process and, if necessary, to achieve a shorter overall execution duration than if the application were executed directly. This can lead to an overall improved optimization of the execution of the process.

Within the meaning of the present application, an execution path is a series of applications of the process to be executed serially one after the other within the graph representation of the process. Execution paths can, for example, represent subprocesses of the process.

According to one example embodiment of the present invention, when assigning the applications to be executed to the processor units, it is taken into account that all applications of the directed acyclic graph are executed.

This can achieve a technical advantage that the complete process is executed and all applications of the process are assigned to corresponding processor units for execution.

According to one example embodiment of the present invention, when assigning the applications to be executed to the processor units and when calculating the shortest execution paths, it is taken into account whether an application can be executed by any processor unit or is to be executed by a specific processor unit, in particular when the plurality of processor units comprise processor units of different processor types.

This can provide the technical advantage that different applications can, if appropriate, only be executed by certain processor units or are to be executed according to the process. For example, it can be provided that individual applications are to be executed by a graphics processor GPU instead of by a central processing unit CPU. By taking this into account when calculating the execution paths, these applications can be assigned to the relevant CPU or GPU. The restriction that certain applications can only be executed on certain processors places a constraint on the possible execution time plans and as a whole on the optimization of the execution of the process. By taking into account the constraint on the execution of individual applications, an improved optimization of the execution of the process can be achieved.

According to one example embodiment of the present invention, the optimization is effected by applying an optimization algorithm to the directed acyclic graph.

This can achieve a technical advantage that a precise and rapid optimization can be achieved.

According to one example embodiment of the present invention, the optimization is effected by applying a search algorithm, in particular an A* algorithm, to the directed acyclic graph.

This can achieve a technical advantage that a precise and rapid optimization can be achieved. The A* algorithm is set up to find an optimized execution time plan for each of the processor units with the shortest execution duration of the application to be executed. For this purpose, for each processor unit the A* algorithm finds an execution path with the shortest execution duration through the directed acyclic graph.

According to one example embodiment of the present invention, the plurality of processors comprises central processing units CPU and/or graphics processors GPU.

This can provide the technical advantage of optimizing processes in which applications are to be executed on CPUs and/or GPUs.

According to one example embodiment of the present invention, the process is a control process of a vehicle.

This can provide a technical advantage of providing a precise vehicle controlling that requires reduced computing capacity due to the optimized control process.

According to a further aspect of the present invention, a computing unit is provided which is configured to carry out the method for optimizing an execution of a process encompassing a plurality of applications by means of a plurality of processor units according to one of the above-described embodiments of the present invention.

According to a further aspect of the present invention, a computer program product is provided, comprising commands which, when the program is executed by a data processing unit, cause the data processing unit to carry out the method for optimizing an execution of a process encompassing a plurality of applications by means of a plurality of processor units according to one of the above-described embodiments of the present invention.

Exemplary embodiments of the present invention are explained with reference to the figures.

### BRIEF DESCRIPTION OF THE DRAWINGS

FIG. 1 shows a schematic representation of a process with a plurality of applications, according to an example embodiment of the present invention.

FIGS. 2A-2D shows graphical representations of a method for optimizing a process with a plurality of applications according to an example embodiment of the present invention.

FIG. 3 shows a flow chart of the method for optimizing a process with a plurality of applications according to an example embodiment of the present invention.

FIG. 4 shows a schematic representation of a computer program product, according to an example embodiment of the present invention.

### DETAILED DESCRIPTION OF EXAMPLE EMBODIMENTS

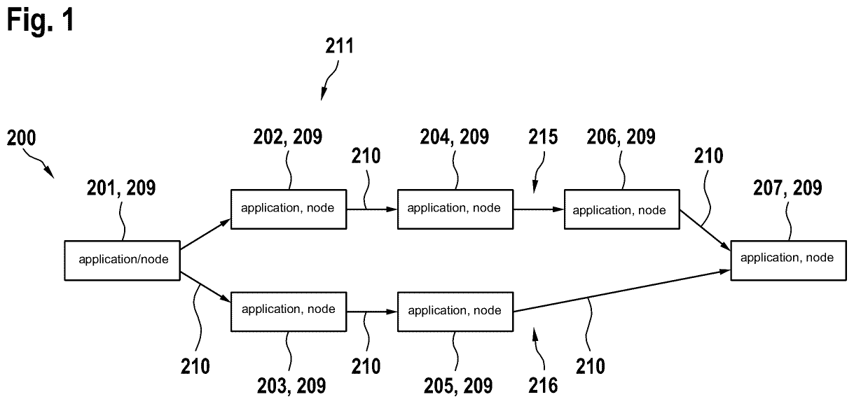

FIG. 1 shows a schematic representation of a process 200 with a plurality of applications 201, 202, 203, 204, 205, 206, 207.

The process 200 shown in FIG. 1 comprises a plurality of applications 201, 202, 203, 204, 205, 206, 207, which are arranged in a graph representation relative to one another. The process 200 may, for example, be a control process of a vehicle, wherein the different applications 201, 202, 203, 204, 205, 206, 207 represent different processing steps within the process 200.

In FIG. 1, the process 200 is shown in a graph representation in the form of a directed and acyclic graph 211. Here the individual applications 201, 202, 203, 204, 205, 206, 207 are represented as nodes 209 of the directed acyclic graph 211, which are connected to each other via directed edges 210. The directed edges 210 are shown as arrows, which represent a direction of data processing by the various applications 201, 202, 203, 204, 205, 206, 207. The direction of the arrows of the directed edges 210 represents a direction of data processing starting from the first application 201 toward the last application 207 of the process 200. In the embodiment shown, the directed graph 211 has two execution paths 215, 216. The execution paths 215, 216 extend in parallel between the first application 201 and the seventh application 207. The execution path 215 includes the second application, the fourth application and the sixth application, while the execution path 216 includes the third application and the fifth application. The parallel arrangement of the execution paths 215, 216 represents a parallel executability of the applications 201, 202, 203, 204, 205, 206, 207 of the two execution paths 215, 216.

The illustrated process 200 and in particular the illustrated graph representation is merely exemplary and is not intended to limit the present invention. In particular, the present invention may be applied to any processes 200 having any number of applications, each arranged in any number of execution paths relative to one another.

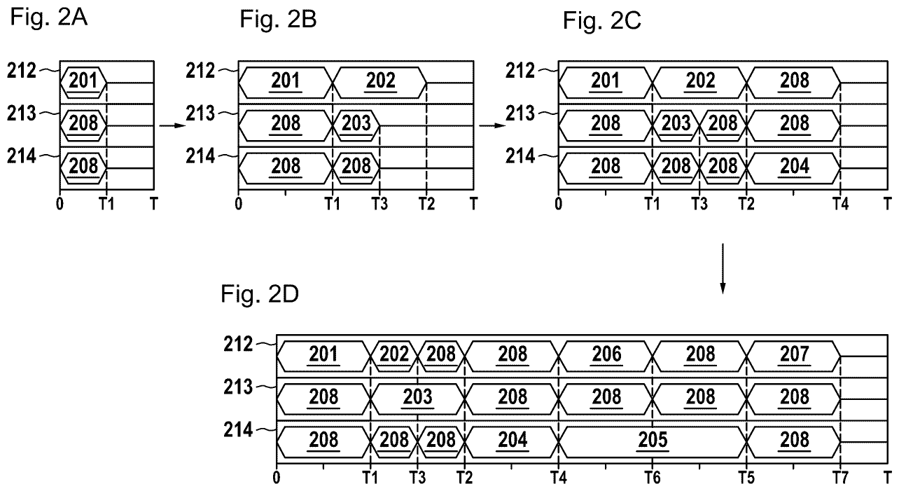

FIGS. 2A-2D show graphic representations of a method 100 for optimizing a process 200 with a plurality of applications 201, 202, 203, 204, 205, 206, 207 according to an embodiment.

In the following, an optimization of an execution of the process 200 from FIG. 1 according to the method 100 according to the present invention for optimizing an execution of a process 200 with a plurality of applications 201, 202, 203, 204, 205, 206, 207 by means of a plurality of processor units is illustrated using FIGS. 2A-2D.

The functioning of the method 100 according to the present invention is explained below based on the exemplary process 200 from FIG. 1. However, the method 100 according to the present invention is not intended to be limited to such a process 200; rather, it can be carried out for any processes 200 with any number of applications 201, 202, 203, 204, 205, 206, 207.

In the example shown, an execution of the process 200 by three different processor units is described. The processor units can be designed, for example, as central processing units CPU and/or as graphics processors GPU. In the example shown, two processor units are designed as CPU and one processor unit as GPU.

To optimize an execution of the process 200, an optimized execution time plan is generated for each processor unit, in which a chronological sequence is defined of the applications 201, 202, 203, 204, 205, 206, 207 of the process 200 to be executed by the relevant processor unit. For this purpose, an execution time plan 212, 213, 214 is first assigned to each processor unit and optimized by carrying out the method 100 according to the execution time of the applications 201, 202, 203, 204, 205, 206, 207 to be executed by the processor unit.

In FIG. 2A, three execution time plans 212, 213, 214 for the three processor units are graphically shown. The execution time plans 212, 213, 214 show a time scale from which an execution duration of the applications 201, 202, 203, 204, 205, 206, 207 to be executed by the processor units can be read off.

To optimize the execution of the process 200, according to the method 100 according to the present invention the first application 201 of the process 200 is assigned to a first processor unit for execution of the first application 201. In FIG. 2A, the first processor unit is represented by the execution time plan 212. In addition to assigning the first application 201 to the first processor unit, an end point of the execution of the first application 201 is further defined as a first decision time T1.

The method 100 according to the present invention for optimizing the execution of the process 200 essentially provides for as many applications 201, 202, 203, 204, 205, 206, 207, executable in parallel, of the process 200 as possible to be executed in parallel by the plurality of processor units. However, since the first application 201 of the process 200 arranged as a directed and acyclic graph 211 does not include any applications that can be executed in parallel to this first application 201, the other processor units are assigned corresponding idle applications 208 for the period of execution of the first application 201 by the first processor unit. The idle applications 208 are, as in FIG. 2A, of the same length as the first application 201 and thus have the same execution duration as the first application 201 and end, starting from the start time of the execution of the process 200, at the first decision time T1 of the first application 201.

Based on the execution time plans 212, 213, 214 of FIG. 2A for the first processor unit starting from the first decision point, an execution path with the shortest execution duration through the directed acyclic graph 211 is calculated and a further application of the process 200 that is directly connected to the first application 201 according to the calculated execution path with the shortest execution duration is ascertained and assigned to the first processor unit. According to the directed acyclic graph 211 of the process 200 in FIG. 1, starting from the first application 201 the execution path 215 is the execution path with the shortest execution duration through the directed acyclic graph 211. Although the execution path 215 has more applications than the execution path 216, the execution durations of the individual applications are shorter overall in the execution path 215, so that this results in a shorter overall execution duration of the execution path 215 compared to the execution path 216.

In the execution path 215, the second application 202 is directly connected to the first application 201 via a corresponding edge 210 of the directed acyclic graph 211. Accordingly, in FIG. 2B, the second application 202 is assigned to the first processor unit represented by the execution time plan 212. Furthermore, an end point of the execution of the second application 202 by the first processor unit is defined as a second decision time T2.

Analogous to the first processor unit, a corresponding execution path through the directed acyclic graph 211 is calculated for the further processor units starting from the first application 201 and starting from the first decision time T1, and a further application directly connected to the first application 201 is ascertained and assigned to the relevant processor unit if the process 200 in each case has correspondingly parallel execution paths. In the example shown, the process 200 has the execution paths 215, 216 arranged in parallel, so that for the second processor unit, which is represented by the execution time plan 213, the third application 203 is identified as an application that can be executed in parallel with the second application 202 and is directly connected to the first application 201 and is assigned to the second processor unit. Furthermore, an end point of the execution of the third application 203 is defined as a third decision time T3.

For the case in which the process 200 does not have any parallel execution paths 215, 216, or the number of available processor units exceeds the number of execution paths 215, 216 arranged in parallel, an idle application 208 is assigned to each of the remaining processor units. The idle application 208 is here not an application of the process 200 to be optimized, but represents an idle state of the processor unit executing the idle application 208. In the example shown in FIG. 1, the process 200 has only two execution paths 215, 216 that can be executed in parallel and thus, in addition to the applications 202, 203 that can be executed in parallel, has another application that can be executed in parallel with these two applications 202, 203. An idle application 208 is thus assigned to the third processor unit. The execution duration of the idle application 208 is defined as the earliest decision time of the two decision times of the second application 202 or of the third application 203. In the example shown, the execution duration of the third application 203 is shorter than the execution duration of the second application 202, so that the third decision time T3 is arranged closer in time to the first decision time T1 than the second decision time T2 of the second application 202. Accordingly, the idle application 208 to be executed by the third processor unit is limited in its execution to the third decision time T3.

In FIG. 2C, due to the longer execution duration of the second application 202 compared to the third application 203, a further idle application 208 is also assigned to the second and third processor units. According to the present invention, the idle applications 208 are thus assigned to the processor units in such a way that, up to a decision time, either an actual application 201, 202, 203, 204, 205, 206, 207 of the process 200 or a corresponding idle application 208 is assigned to the processor unit.

Analogous to the method steps described above, after the applications 202, 203 have been assigned and the execution time plans 212, 213, 214 have been filled with idle applications 208 up to the second decision time T2 of the second application 202, an execution path with the shortest application time through the directed acyclic graph 211 of the process 200 is calculated for this second decision time T2 starting from the second application 202 and an application on the calculated execution path with the shortest execution duration, directly connected to the second application 202, is identified and assigned to one of the processor units. In the example shown in FIG. 1, starting from the second application 202, the execution path with the shortest execution duration is given by the execution path 215 of the graph 211. On the execution path 215, the fourth application 204 is directly connected to the second application 202. However, compared to the other applications and in particular compared to the first to third applications 201 to 203, the fourth application 204 is characterized in that the fourth application 204 is to be executed by the graphics processor GPU, which in the example shown is represented by the third processor unit. Accordingly, in FIG. 2C the fourth application 204 is assigned to the third processor unit represented by the execution time plan 214, and an end point of the execution of the fourth application 204 is defined as a fourth decision time T4.

Analogously, for the further processor unit, starting for the second decision time T2 for the third application 203, a corresponding execution path with the shortest execution duration is calculated and a further application directly connected to the third application 203 is identified. In the embodiment shown in FIG. 1, the fifth application 205 of the execution path 216 is directly connected to the third application 203 and can thus theoretically be executed in parallel to the fourth application 204. However, in the example shown, analogously to the fourth application 204 the fifth application 205 is also characterized in that it is also to be executed exclusively by the graphics processor GPU of the third processor unit, which is represented by the execution time plan 214. A parallel execution of the applications 204, 205 is therefore not possible.

The directed acyclic graph 211 thus has no further application that can be executed in parallel with the fourth application 204. Following the above, the further processor units, which are represented by the execution time plans 212, 213, are each assigned an idle application 208 starting from the second decision time T2. The idle application 208 is here limited to the fourth decision time T4 of the fourth application 204, so that the three processor units in turn do not execute any further application at the fourth decision time T4.

Analogous to the above embodiments, for the fourth decision time T4, starting from the third application 203, an execution path with the shortest execution duration through the directed acyclic graph 211 is calculated and a further application arranged on the calculated execution graph and directly connected to the third application 203 is identified. As described above, this identifies the fifth application 205, which, however, is to be executed exclusively by the third processor unit. Accordingly, in FIG. 2D, the fifth application 205 is assigned to the third processor unit and thus to the execution time plan 214 starting from the fourth decision time T4 and a corresponding fifth decision time T5 is defined.

Furthermore, for the fourth application 204 a corresponding execution path with the shortest execution duration is calculated which is given by the execution path 215, following the example of FIG. 1, and a further application arranged in the execution path and directly connected to the fourth application 204 is identified. The sixth application 206, which is directly connected to the fourth application 204 in the execution path 215, is thus assigned to the first processor unit, which is represented by the execution time plan 212, and a corresponding sixth decision time T6 is defined as the end point of the execution of the sixth application 206.

Since the process 200 has only two execution paths 215, 216 that can be executed in parallel, the second processor unit, which is represented by the execution time plan 213, is assigned corresponding idle applications 208 that run on the one hand from the decision time T4 to the sixth decision time T6 of the sixth application 206 and on the other hand from the sixth decision time T6 to the fifth decision time T5 of the fifth application 205.

Following the method described above, a corresponding execution path with the shortest execution duration through the directed and acyclic graph 211 is then calculated for the sixth application 206 and an application arranged on the calculated execution path and directly connected to the sixth application 206 is identified. Following the examples described, the calculated execution path with the shortest execution duration is given by the execution path 215 and the seventh application 207 arranged on the execution path 215 and directly connected to the sixth application 206 is thus assigned to the first processor unit and an end point of the execution of the seventh application 207 is identified as the seventh decision time T7.

Since the seventh application 207 represents the last application of the process 200 and the process 200 therefore has no further applications that can be executed in parallel with the seventh application 207, the execution time plans 213, 214 are each filled with an idle application 208 starting from the fifth decision time T5 up to the seventh decision time T7 of the seventh application 207. Since the seventh application 207 is the last application of the process 200, the method 100 is terminated. The optimized execution time plans 212, 213, 214 created in this way for the plurality of processor units represent in their entirety the optimized execution of the process 200 of FIG. 1.

The method 100 according to the present invention can be carried out, for example, during programming or implementation of the process 200 to be executed in each case, and corresponding optimized execution time plans 212, 213, 214 can be created. The optimized execution time plans 212, 213, 214 created in this way can subsequently be stored in a corresponding database or directly in the execution code of the process 200, so that when the process 200 is executed, for example by a vehicle controller, the process 200 can be executed directly according to the calculated optimized execution time plans 212, 213, 214.

When the process 200 is executed according to the calculated optimized execution time plans 212, 213, 214, an optimized utilization of the available processor units can be achieved. This makes it possible to achieve a resource-saving execution of the process 200 by minimizing possible waiting times for executing the various applications 201, 202, 203, 204, 205, 206, 207 of the process 200 through the full utilization of the available processor units, and thereby reducing the occupancy of the processor units for executing the process 200 to a minimum time duration.

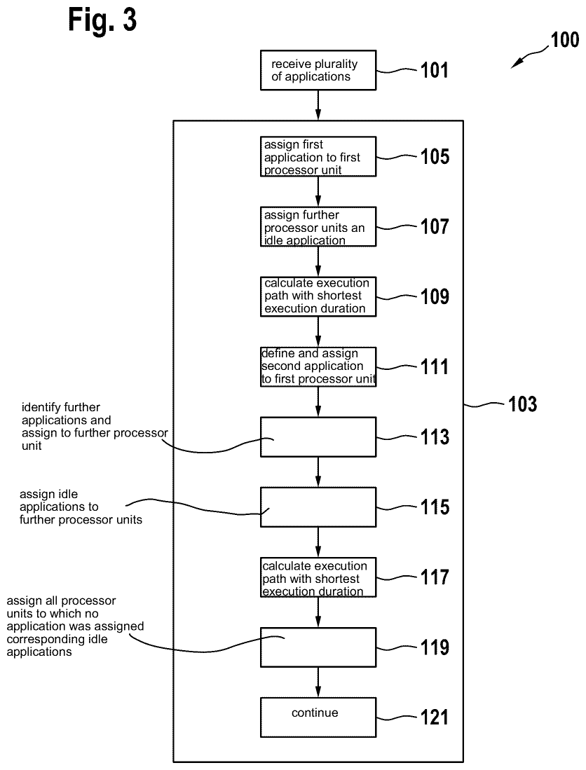

FIG. 3 shows a flowchart of the method 100 for optimizing a process 200 with a plurality of applications 201, 202, 203, 204, 205, 206, 207 according to an embodiment.

According to the method 100 according to the present invention, in order to optimize an execution of a process 200 encompassing a plurality of applications 201, 202, 203, 204, 205, 206, 207 by means of a plurality of processor units, in a first method step 101 a plurality of applications 201, 202, 203, 204, 205, 206, 207 of the process 200 to be executed on the plurality of processor units are first received.

In a further method step 103, the execution of the process 200 is optimized by optimized execution time plans 212, 213, 214 of the plurality of processor units being determined, wherein in an optimized execution time plan for a processor unit, starting from a start time of the execution of the process, a chronological sequence is defined of the applications 201, 202, 203, 204, 205, 206, 207 to be executed by the processor unit according to the execution sequence of the process 200. The optimized execution time plans 212, 213, 214 are characterized in that when the applications 201, 202, 203, 204, 205, 206, 207 of the process 200 are executed in parallel by the processor units, the execution duration of the process 200 is minimal.

For this purpose, in a method step 105, a first application 201 of the process 200 is assigned to a first processor unit for executing the first application 201 starting from a start time of the execution of the process 200 and an end point of the execution of the first application 201 is defined as a first decision time.

In a further method step 107, the further processor units are each assigned an idle application 208 for execution by the processor units from the start time of the execution of the process 200 until the first decision time T1.

In a further method step 109, starting from the first application 201 and the first decision time T1, an execution path with a shortest execution duration through the directed acyclic graph 211 is calculated, wherein the execution duration of the execution path is formed as a sum of execution durations of the applications 201, 202, 203, 204, 205, 206, 207 of the execution path.

In a further method step 111, a second application 202 of the calculated execution path, which application is directly connected to the first application 201, is defined and assigned to the first processor unit for execution thereby. Furthermore, an end point of the execution of the second application 202 is defined as a second decision time T2.

In a further method step 113, further applications that are directly connected to the first application 201 and can be executed in parallel to the second application 202 and that do not belong to the execution path with the shortest execution duration are identified and assigned to the further processor units, and end points of the executions of the correspondingly assigned applications are defined as further decision times T3, T4, T5, T6, T7 if the directed acyclic graph 211 has further execution paths in addition to the ascertained execution path.

In a further method step 115, idle applications 208 are assigned to the further processor units for execution by processor units if the directed acyclic graph 211 of the process 200 has no further execution paths in addition to the identified execution path with the shortest execution duration, or if a number of execution paths is smaller than a number of available processor units. The executions of the idle applications 208 are limited here to the period between the first decision time T1 and the second decision time T2.

In a further method step 117, an execution path with the shortest execution duration through the directed acyclic graph 211 is calculated for the second application 202 starting from the second decision time T2, a further application 203, 204, 205, 206, 207 arranged on the calculated execution path, which application is directly connected to the second application 202, is identified and is assigned to the first processor unit or to a further processor unit for execution. An end point of the execution of the further application 201, 202, 203, 204, 205, 206, 207 is identified here as a further decision time T3 to T7.

In a further method step 119, all processor units to which no application was assigned for the relevant decision time are assigned corresponding idle applications 208 for execution of the idle applications up to a decision time that is next in time from the relevant decision time.

In a further method step 121, the calculation of execution paths for the already-identified and assigned further applications and the corresponding assignment of further applications directly connected to the already-assigned applications to the respective processor units, the definition of further decision times, and the assignment of idle applications 208 to the processor units for each of which no application to be executed could be identified, are continued until the last application 207 of the directed acyclic graph 211 of the process 200 is reached. The sequences of applications 201, 202, 203, 204, 205, 206, 207 to be executed by the respective processor units and idle applications 208 to be executed, ascertained in this way for the individual processor units, are subsequently identified as optimized execution time plans 212, 213, 214 of the respective processor units.

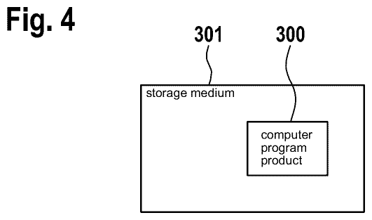

FIG. 4 shows a schematic representation of a computer program product 300, comprising commands which, when the program is executed by a computing unit, cause the computing unit to carry out the method 100 for optimizing an execution of a process 200 encompassing a plurality of applications 201, 202, 203, 204, 205, 206, 207 by means of a plurality of processor units.

In the embodiment shown, the computer program product 300 is stored on a storage medium 301. The storage medium 301 can be any storage medium from the related art.

1-11. (canceled)

12. A method for optimizing an execution of a process encompassing a plurality of applications by means a plurality of processor units, comprising the following steps:
receiving a plurality of applications, which are to be to be executed on a plurality of processor units, of a process to be executed, wherein an execution sequence of the applications is defined by the process; and
optimizing the execution of the process by determining optimized execution time plans for the plurality of processor units, wherein in each optimized execution time plan for a processor unit of the plurality of processor units, a chronological execution sequence of the applications to be executed by the processor unit according to the execution sequence of the process is defined based on a starting time for the execution of the process, and wherein the optimized execution time plans are such that when applications of the process are executed in parallel by the processor units according to the optimized execution time plans, an execution duration of the process is minimal.

13. The method according to claim 12, wherein the plurality of applications are arranged in a directed acyclic graph, wherein in the directed acyclic graph, the applications are represented as nodes, and the execution sequence of the applications is defined via edges connecting the nodes.

14. The method according to claim 13, wherein the optimization includes:
assigning a first application of the directed acyclic graph to a first processor unit for executing the first application starting from a start time of the execution of the process by the first processor unit and defining an end point of the execution of the first application as a first decision time;
assigning an idle application to each further processor unit for execution by the further processor units from the start time of the execution of the process to the first decision time, wherein during the execution of the idle application, the further processor unit is put into an idle state;
calculating an execution path with a shortest execution duration through the directed acyclic graph starting from the first application of the directed acyclic graph, wherein the execution path includes the applications connected in the directed acyclic graph to the first application and to each other with corresponding edges, and wherein an execution duration of the execution path is formed as a sum of execution durations of the applications of the execution path;
assigning a second application, with a shortest execution duration, directly connected to the first application in the execution path, to the first processor unit for execution by the first processor unit starting from the first decision time and defining an end point of the execution of the second application as a second decision time;
assigning further applications in the directed acyclic graph which are directly connected to the first application and do not belong to the execution path with the shortest execution duration, to the further processor units for execution by the further processor units starting from the first decision time and defining end points of the execution of the further applications as further decision times, when the directed acyclic graph includes, in addition to the execution path with the shortest execution duration, further execution paths starting from the first application and arranged in parallel with the execution path with the shortest execution duration;
assigning idle applications to further processor units for execution of the idle applications by the further processor units starting from the first decision time up to the second decision time or up to an earliest decision time from a group of the second decision time and the further decision times, when the directed acyclic graph does not include, in addition to the execution path with the shortest execution duration, any further execution path starting from the first application and arranged in parallel with the execution path with the shortest execution duration, or when a number of the further processor units is greater than a number of the further execution paths;
calculating, for the second application to be executed by the first processor unit and the further applications to be executed by the further processor units in parallel with the second application, execution paths with in each case the shortest execution durations through the directed acyclic graph, starting in each case from the second application or from the further applications of the directed acyclic graph, and assigning further applications connected, in the execution paths with the shortest execution durations, directly to the second application or to the further applications to the first processor unit or to the further processor units for execution by the first processor unit or the further processor units starting from the second decision time or the further decision times, and defining endpoints of the executions of the further applications as further decision times;
assigning idle applications to all processor units for which no application was assigned for a relevant decision time for execution of the idle application until a decision time that is chronologically next from the relevant decision time;
continuing with the calculation of execution paths for the further applications and the assignment of further applications of the calculated execution paths to the respective processor units for executing the applications and the assignment of idle applications to the processor units until a last application of the directed acyclic graph is reached, and defining for each processor unit sequences, ascertained for the processor units, of applications and idle applications to be executed by the respective processor units as execution time plans of each of the processor units.

15. The method according to claim 14, wherein when assigning the applications to be executed to the processor units, it is taken into account that all applications of the directed acyclic graph are executed.

16. The method according to claim 14, wherein when assigning the applications to be executed to the processor units and when calculating the shortest execution paths, it is taken into account whether an application can be executed by any processor unit or is to be executed by a specific processor unit, when the plurality of processor units include processor units of different processor types.

17. The method according to claim 12, wherein the optimization is effected by an application of an optimization algorithm to the directed acyclic graph.

18. The method according to claim 12, wherein the optimization is effected by an application of a search algorithm to the directed acyclic graph, the search algorithm being an A* algorithm.

19. The method according to claim 12, wherein the plurality of processor units includes central processing units (CPU) and/or graphics processors (GPU).

20. The method according to claim 12, wherein the process is a control process of a vehicle.

21. A computing unit configured to optimize an execution of a process encompassing a plurality of applications by means a plurality of processor units, thye computing unit configured to:
receive a plurality of applications, which are to be to be executed on a plurality of processor units, of a process to be executed, wherein an execution sequence of the applications is defined by the process; and
optimize the execution of the process by determining optimized execution time plans for the plurality of processor units, wherein in each optimized execution time plan for a processor unit of the plurality of processor units, a chronological execution sequence of the applications to be executed by the processor unit according to the execution sequence of the process is defined based on a starting time for the execution of the process, and wherein the optimized execution time plans are such that when applications of the process are executed in parallel by the processor units according to the optimized execution time plans, an execution duration of the process is minimal.

22. A non-transitory computer-readable medium on which is stored a computer program for optimizing an execution of a process encompassing a plurality of applications by means a plurality of processor units, the computer program, when executed by a data processing unit, causing the data processing unit to perform the following steps:
receiving a plurality of applications, which are to be to be executed on a plurality of processor units, of a process to be executed, wherein an execution sequence of the applications is defined by the process; and
optimizing the execution of the process by determining optimized execution time plans for the plurality of processor units, wherein in each optimized execution time plan for a processor unit of the plurality of processor units, a chronological execution sequence of the applications to be executed by the processor unit according to the execution sequence of the process is defined based on a starting time for the execution of the process, and wherein the optimized execution time plans are such that when applications of the process are executed in parallel by the processor units according to the optimized execution time plans, an execution duration of the process is minimal.
